(19) United States
(12) Patent Application Publication
(10) Pub. No.: US 2024/0296647 A9
(43) Pub. Date: Sep. 5, 2024

(54) UNIVERSAL VISUAL CORRESPONDENCE IMAGING SYSTEM AND METHOD

(71) Applicant: Laplace Robotics Inc., North York (CA)

(72) Inventor: Rae Chan JEONG, North York (CA)

(21) Appl. No.: 18/472,496

(22) Filed: Sep. 22, 2023

Related U.S. Application Data
(60) Provisional application No. 63/409,048, filed on Sep. 22, 2022.

(51) Int. Cl. G06V 10/20; G06T 7/50; G06V 10/25; G06V 10/77; G06V 10/774; G06V 20/70

(52) U.S. Cl. CPC G06V 10/255; G06T 7/50; G06V 10/25; G06V 10/7715; G06V 10/774; G06V 20/70

(57) ABSTRACT

System and method for detecting a target object within an environment, including obtaining a two-dimensional input image of a scene within the environment; generating, using a machine learning based feature generation model, a feature map of respective feature vectors for the input image; comparing the feature vectors included in the feature map with reference feature vectors generated by the feature generation model based on reference points within a reference image, wherein the reference image includes an reference object instance that corresponds to the target object; based on the comparing, identifying points of interest in the input image that correspond to the reference points; and determining a presence of the target object in the environment based on the comparing.

### RELATED APPLICATIONS

This application claims benefit of and priority to United States Provisional Patent Application No. 63/409,048 filed Sep. 22, 2022, the contents of which are incorporated herein by reference.

### FIELD

This disclosure relates generally to imaging systems, and more particularly to a universal visual correspondence imaging system and method for identifying corresponding points in images.

### BACKGROUND

In industrial or commercial settings, objects are often required to be detected, recognized, tracked, picked, and packed as part of a real-time industrial process. The process of picking, placing, and packing is also referred to as singulating and sorting in the industry. Imaging systems can be applied to industrial processes to perform live detection, recognition and tracking tasks to support singulating and sorting operations, as well as to enable visual inspection for quality control purposes.

Live detection, recognition and tracking imaging systems can be used in various environments, such as manufacturing plants. By way of example, a live conveyor may move a large volume of objects (for example, mass produced objects) from place to place. Live detection and live tracking of the moving objects are required for the physical act of picking the objects at the correct position and angle. The picked objects can then be either placed in some location, packed in boxes, located on another conveyor, or used by another system. In the context of visual inspection applications, live detection and live tracking of the moving objects can be combined with automated inspection to detect and track objects with defects and anomalies. Such objects can be singulated to be removed from a normal processing line for one or more alternative actions such as further inspection, remedial work, or disposal.

The shape, size, texture, pose (rotation and position in space), and other characteristics of mass-processed or mass-produced objects can vary across different industrial processes and applications, as well as within the same industrial process. For example, within a same industrial process, objects having regular structures (such as boxes or bars) can have different poses relative to each other as they progress through a processing line. In some industrial processes, the objects being processed may also have irregular shapes (such as different chicken parts in the food industry) in addition to varying poses. The objects with irregular shapes can have variance in their structure and thus can be particularly challenging for detection and recognition compared to objects that have regular and consistent structures.

Accordingly, a live detection, recognition and tracking imaging system is ideally able to detect, recognize, and track the (possibly live moving) objects for various goals such as pick-and-place, pick-and-pack, singulate-and-sort, and visual quality control.

Intelligent imaging systems have been proposed that use advanced machine learning-based algorithmic models that are trained to recognize, track, and inspect objects. For these systems, common issues such as object variation, object pose variation, image sensor pose variation, and background variation can significantly impact the reliability of these algorithms within the domain that they have been trained. To improve model reliability, large manually labelled training datasets are often required. Further, the models can become out of date as the process and environment evolves.

Some intelligent imaging systems require the use of cameras that can provide depth data (e.g., cameras that generate 3D image data) in order to enable object detection and tracking. However, cameras that generate depth data can be expensive.

Accordingly, there is a need for an intelligent live detection, recognition and tracking imaging system that can be efficiently trained to perform efficient and accurate detection, recognition tasks in an industrial process that can experience wide variations in one or both of object structure and object pose. There is a need for such a system that can be gradually updated and improved by getting feedback and further data from the environment in which it is operating. There is also a need for such a system that can be implemented using conventional two-dimension image data captured using commonly available and inexpensive 2D image capture devices.

### SUMMARY

According to an example aspect, a computer implemented method and system is described that includes: acquiring a set of training images that includes a plurality of corresponding image sets, each corresponding image set including multiple non-identical images wherein a plurality of same physical points are represented at different respective pixel locations across the multiple non-identical images; generating an image label set for the set of training images, the image label set identifying, by respective pixel locations, groups of the same physical points across the multiple images included in each corresponding image set; training a machine learning based feature generation model using the set of training images and the image label set to generate pixel feature vectors with an objective of generating identical feature vectors for pixel locations that correspond to the same physical points; generating, using the machine learning based feature generation model, respective reference feature vectors for a plurality of pixel locations of a reference image, each of the reference feature vectors corresponding to a respective reference point; generating, using the machine learning based feature generation model, a feature map of respective feature vectors for pixel locations of an input image; and identifying points-of-interest in the input image based on a comparison of the respective feature vectors generated for the input image with the reference feature vectors.

According to one example aspect, a computer implemented method for detecting a target object within an environment is described. The method includes obtaining a two-dimensional input image of a scene within the environment; generating, using a machine learning based feature generation model, a feature map of respective feature vectors for the input image; comparing the feature vectors included in the feature map with reference feature vectors generated by the feature generation model based on reference points within a reference image, wherein the reference image includes an reference object instance that corresponds to the target object; based on the comparing, identifying points of interest in the input image that correspond to the reference points; and determining a presence of the target object in the environment based on the comparing.

According to some examples of the preceding aspect, the two-dimensional input image is obtained using a camera and includes two dimensional (2D) color data or grayscale data arranged in an array of pixels, each pixel corresponding to respective physical location within the scene, and the feature generation model generates the feature map in the absence of depth data for the pixels of the input image.

According to examples of one or more of the preceding aspects, the method comprises training the feature generation model, the training comprising: obtaining a set of training images that includes a plurality of corresponding image sets, each corresponding image set including multiple non-identical images wherein a plurality of same physical points are represented at different respective pixel locations across the multiple non-identical images; generating an image label set for the set of training images, the image label set identifying, by respective pixel locations, groups of the same physical points across the multiple images included in each corresponding image set; and using the set of training images and the image label set to train the feature generation model to generate pixel feature vectors with an objective of generating identical feature vectors for pixel locations that correspond to the same physical points.

According to some examples of one or more of the preceding aspects, training the feature generation model comprises generating depth information for each of the corresponding image sets using a machine learning based depth generating model, wherein the generated depth information is used together with the set of training images and the image label set to train the feature generation model.

According to some examples of one or more of the preceding aspects, the method comprises: obtaining, in addition to the two-dimensional input image, one or more further two-dimensional input images of the scene, the two-dimensional input image and the one or more further two-dimensional input images each corresponding to a different respective camera view of the scene; generating, using the machine learning based feature generation model, a respective feature map of respective feature vectors for each of the one or more further two-dimensional input images; and further comparing the further feature vectors included in the further feature maps with the reference feature vectors. Identifying the points of interest in the input image is also based on the further comparing.

According to some examples of one or more of the preceding aspects, the method comprises obtaining the reference feature vectors, including: obtaining the reference image and one or more further reference images, the one or more further reference images also each including a respective reference object instance that corresponds to the target object, the reference image and the one or more further reference images each corresponding to a different respective camera view; identifying, for each of the reference points, a corresponding set of points across the reference image and the one or more further reference images that each map to a same physical location of the target object; for each of the reference points, using the feature generation model to generate respective corresponding point feature vectors for each of the points included in the set of points corresponding to the reference point; and for each reference point, generating a respective one of the reference feature vectors based on the respective corresponding point feature vectors generated for each of the points included in the set of points corresponding to the reference point.

According to some examples of the preceding aspect, the method comprising identifying the reference points, including: receiving, through a user interface, user inputs selecting locations on the two-dimensional input image as the reference points, as part of a configuration phase.

According to some examples of one or more of the preceding aspects, one or more cameras that are capable of capturing two-dimensional images but not enabled to capture an image depth dimension are used to obtain each of the two-dimensional input image, the one or more further two-dimensional input images, the reference image and the one or more further reference images.

According to some examples of one or more of the preceding aspects, the method comprises retraining the feature generation model based on an updated set of training images that include one or more images previously obtained as two-dimensional input images of the scene.

According to some examples of one or more of the preceding aspects, the method comprises, prior to training the feature generation model: presenting, using a user interface, selectable training mode options including a 3D scene learning mode and a 2D scene learning mode; and receiving a user input selecting one of the training mode options, wherein: (i) when the user input selects the 3D scene learning mode, the training includes generating depth information for each of the corresponding image sets using a machine learning based depth generating model and the generated depth information is used together with the set of training images and the image label set to train the feature generation model, and (ii) when the user input selects the 2D scene learning mode, the training is performed without depth information.

According to some examples of one or more of the preceding aspects, obtaining the set of training images comprises, for each of the corresponding image sets: obtaining at least a first image and a second image using different camera views.

According to some examples of one or more of the preceding aspects, obtaining the set of training images comprises, for each of the corresponding image sets: obtaining a first image that includes the object instance; applying a translation function to the first image to obtain at least a second image.

According to some examples of one or more of the preceding aspects, the method comprises performing a physical action in respect of the target object based on the comparing.

According to a further example aspect is a processing system comprising one or more processing devices and one or more memories coupled to the one or more processing devices, the processing system being configured for detecting a target object within an environment by performing one or more of the preceding methods.

According to a further example aspect is a computer readable medium storing a set of non-transitory executable software instructions that, when executed by one or more processing devices, configure the one or more processing devices to perform one or more of the preceding methods.

### BRIEF DESCRIPTION OF THE DRAWINGS

Reference will now be made, by way of example, to the accompanying drawings which show example embodiments of the present application, and in which:

FIG. 1 is a block diagram illustrating a correspondence imaging system according to example implementations.

FIG. 2 is a flow diagram illustrating operations performed by a configuration module of the correspondence imaging system of FIG. 1.

FIG. 3 is a diagram illustrating operations performed by a correspondence module of the correspondence imaging system of FIG. 1.

FIG. 4 is a diagram showing regions-of-interest and points-of-interest overlaid on an image, illustrating operations of the correspondence imaging system of FIG. 1.

FIG. 5 is a block diagram illustrating learning modes that can be applied for training the correspondence imaging system of FIG. 1.

FIG. 6 is a block diagram of a training phase for the correspondence imaging system of FIG. 1.

FIG. 7 illustrates an example of a corresponding image set for use during training of the correspondence imaging system FIG. 1.

FIG. 8 is a block diagram showing an image labelling process performed by the correspondence imaging system of FIG. 1.

FIG. 9 illustrates an example of a further example of a corresponding image set for use during training of the correspondence imaging system FIG. 1.

FIG. 10 illustrates an example of yet a further example of a corresponding image set for use during training of the correspondence imaging system FIG. 1.

FIG. 11 is a block diagram of a processing unit that can be used to implement modules and units of the correspondence imaging system of FIG. 1 according to example embodiments.

Similar reference numerals may have been used in different figures to denote similar components.

### DESCRIPTION OF EXAMPLE EMBODIMENTS

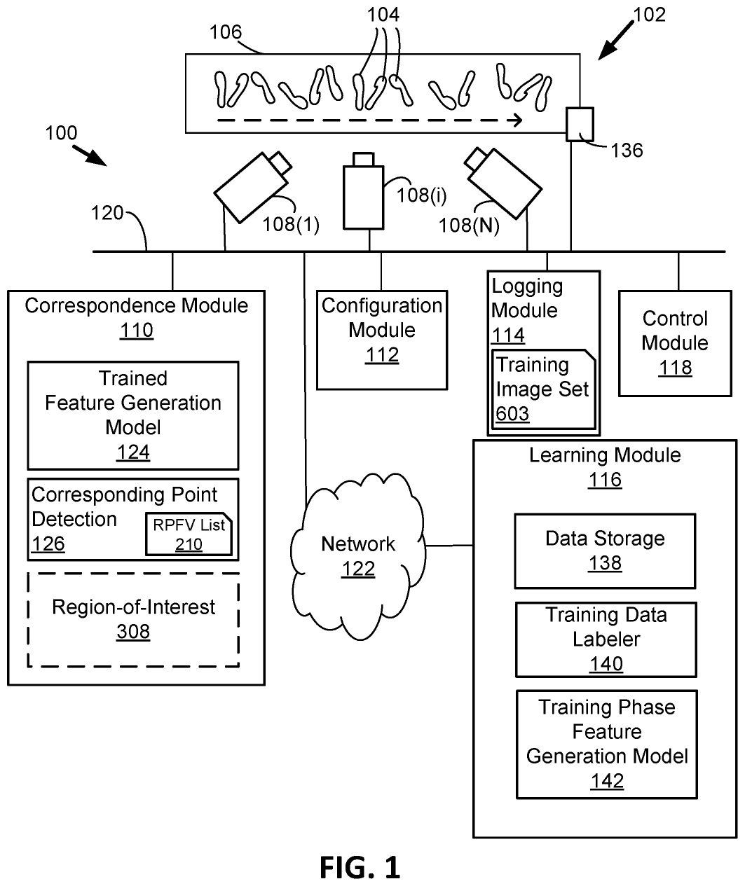

FIG. 1 depicts an example embodiment of a universal visual correspondence imaging system (hereafter system 100) for identifying corresponding points across multiple images. In the example of FIG. 1, system 100 is shown interacting with an environment 102. The environment 102 can, for example, include an industrial or commercial environment that requires a volume of objects 104 to be detected, recognized and tracked. In the illustrated example, the environment 102 is an industrial process in which a series of mass produced or mass processed objects 104 are advanced along a processing line on a conveyor belt 106. System 100 can be adapted for application to many different types of environments. By way of non-limiting example, environment 102 can, in different applications, be: a production line or processing line of a factory where objects 104 are mass produced or mass processed, such as in a manufacturing plant or food processing plant; a picking, routing, packaging and shipping environment such as in a distribution center; a laboratory where objects 104 are the subjects of ongoing observation; a retail store where objects 104 are retail items; or any other environment in which detection, recognition and tracking of objects is required.

As will be noted from the following description, the system 100 can enable target objects to be detected, recognized and tracked based on exposure to a reference image of a same or similar object without requiring the system 100 to be trained using manually labelled training datasets. This can enable a system 100 that can be readily configured to detect, recognize and track many different types of target objects in different applications. Further, the system 100 can use on-going data gathered for a process in an environment to evolve as the process and environment evolve.

In example embodiments, the system 100 can include the following components, each of which will be described in greater detail below: one or more image sensor devices, for example cameras 108(1) to 108(N) (the reference 108(i) is used to denote a generic camera in this disclosure), correspondence module 110, configuration module 112, logging module 114 and learning module 116. As used here, a “module” can refer to a combination of a hardware processing circuit and machine-readable instructions and data (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit.

In some examples, modules can be implemented using suitably configured processor enabled computer devices or systems such as personal computers, industrial computers, laptop computers, computer servers and programmable logic controllers. In some examples, individual modules may be implemented using a dedicated processor enabled computer device, in some examples multiple modules may be implemented using a common processor enabled computer device, and in some examples the functions of individual modules may be distributed among multiple processor enabled computer devices. Further information regarding example processor enabled computer device configurations will be described below.

In the illustrated example, cameras 108(1) to 108(N), correspondence module 110, configuration module 112, and logging module 114 may be located at an industrial process location or commercial site and enabled to communicate with an enterprise or local communications network 120 that can, for example, include wireless links (e.g. a wireless local area network such as WI-FI™ or personal area network such as Bluetooth™), wired links (e.g. Ethernet, universal serial bus, network switching components, and/or routers, or a combination of wireless and wireless communication links. In example embodiments, learning module 116 may be located at a geographic location remote from the industrial process location (for example, a cloud based server) and connected to local communications network 120 through a further external network 122 that may include wireless links, wired links, or a combination of wireless and wireless communication links. External network 122 may include the Internet.

The configuration shown in FIG. 1 is illustrative of one possible system configuration. In some alternative example configurations, one or more of correspondence module 110, configuration module 112, and logging module 114 (or selected functions or components thereof) may alternatively be distributed among one or more geographic locations remote from the location of environment 102 and connected to the remaining modules through external network 122. Similarly, in some alternative examples, learning module 116 (or selected functions or components thereof) may alternatively be located at the location of environment 102 and directly connected to local communications network 120.

In example embodiments, the cameras 108(1) to 108(N) can include one more optical image cameras configured to capture a representation of visible light reflected from a scene that can include one or more objects of interest within the environment 102. By way of example, camera 108(i) can be an optical image video camera configured to generate a structured data output in the form of a sequence of optical image frames. Each image frame (also referred to as an “image” herein) can be organized as two-dimensional (2D) image data arranged as an X by Y array of picture element data structures (e.g., pixels) that are each indexed by a respective (x,y) coordinate pair, where each pixel stores image data that represents one or move values about light reflected from a corresponding point in an observed scene. In some examples, pixel-level image data can take the form of a vector of elements that each represent a respective dimension or channel, with each dimension or channel representing a respective color value (e.g., 3-channel pixel-level Red-Green-Blue (RGB) values in the case of an RGB format, or Hue-Intensity-Saturation (HIS) values in the case of an HIS format). In some examples, pixel-level image data can be a 1-channel pixel level greyscale value. Camera 108(i), which can include an on-board processer, may be configured to generate several optical images (also referred to as image frames) per second, with each frame being an X by Y pixel array of optical data values. In at least some examples, the camera 108(i) can provide metadata with captured images that specifies camera properties of the camera used to capture the images, including for example one or more of camera resolution, zoom, shutter speed, aperture, and camera light sensitivity (ISO).

Cameras 108(1) to 108(N) can be implemented using conventional 2D image capture devices that output 2D image data that does not explicitly include depth information. As used in tis disclosure, a two-dimensional image refers to an image that includes a 2D array of color or greyscale vales but does not include depth values. This enables the system 100 to be implemented using low cost camera equipment. In examples, multiple cameras 108(1) to 108(N) can be arranged to capture a common or partially overlapping scene, with each camera providing a respective view of the scene. In at least some examples the location and pose of each of the cameras 108(1) to 108(N) to a common reference point or respective reference points is known such that the pixel locations in images captured for the different camera views can be mapped to physical locations within a scene that is captured in the images. Although the following description will be provided in the context of one or more cameras 108(i) that are optical image cameras, the image processing methods and systems can be adapted for processing other types of image data. For example, in some applications cameras 108(1) to 108(N) can alternatively or additionally one or more cameras that are configured to measure non-visible electromagnetic energy reflections from points within an observed scene. By way of example, one or more of the cameras 108(1) to 108(N) may be a thermal image camera that is a processor enabled device configured to capture two dimensional thermal data by measuring emitted infrared (IR) or near infrared (NIR) radiation from a scene and calculate surface temperature of one or more objects of interest within the scene based on the measured radiation. Each thermal image camera can be configured to generate a structured data output in the form of a thermal image that includes a two-dimensional (2D) array (X,Y) of temperature values. The temperature values each represent a respective temperature calculated based on radiation measured from a corresponding point or location of an observed scene.

In example embodiments, cameras 108(1) to 108(N) are arranged to capture a scene that includes at least one object 104 that is being processed as part of an industrial process. Correspondence module 110 is configured to receive one or more of the images captured by cameras 108(1) to 108(N), and process the corresponding image data to identify one or more target points (TPs) in the images that respectively correspond to one or more predefined reference points (RPs). The resulting point correspondence data can be applied to facilitate one or more of live detection, recognition and tracking operations in respect of the object 104. For example, a control module 112 can be connected to system 100 that is configured to process the resulting point correspondence data (or data derived from the resulting point correspondence data) and take actions based on such processing. In some examples, the actions may include an inspection decision, such as classifying the object 104 as passing or failing a quality standard. In some examples, the actions may include generating control instructions for one or more processing operations are included in the environment 102. For example, the control instructions may include instructing an automated or robotic routing or picking component 138 to physically route or process a selected object 104.

Three different operational phases of system 100 will now be described according to an example implementation, namely a training phase, a configuration phase and a correspondence phase. The training phase, which includes operations performed by the logging module 114 and the learning module 116, involves initially training and then periodically updating or retraining a training phase feature generation model 142 for subsequent deployment to the correspondence module 110 as a trained feature generation model 124.

The configuration phase, which includes operations performed by the configuration module 112, working in conjunction with the trained feature generation module 114, involves configuring the system 100 to perform a point correspondence task in respect of a specific reference object.

The correspondence phase, which includes operations performed by the correspondence module 110, involves actual performance of the point correspondence task as part of ongoing real-time process that is carried out in the environment 102.

For ease of explanation, these respective phases are described in detail below beginning with configuration phase, followed by correspondence phase, and then training phase.

CONFIGURATION PHASE: In an example implementation, configuration module 112 is used to quickly configure the system 100 to enable the system to perform a point correspondence task in respect of a reference object 104R. In at least some scenarios, configuration can be performed after a general training of the system 100 to perform a point correspondence task (even in scenarios where such training did not include the specific reference object 104R). In at least some scenarios, after configuration, the system 100 can periodically re-enter the training phase to be updated to learn domain specific knowledge and also adapt to changes that may occur in the environment 102.

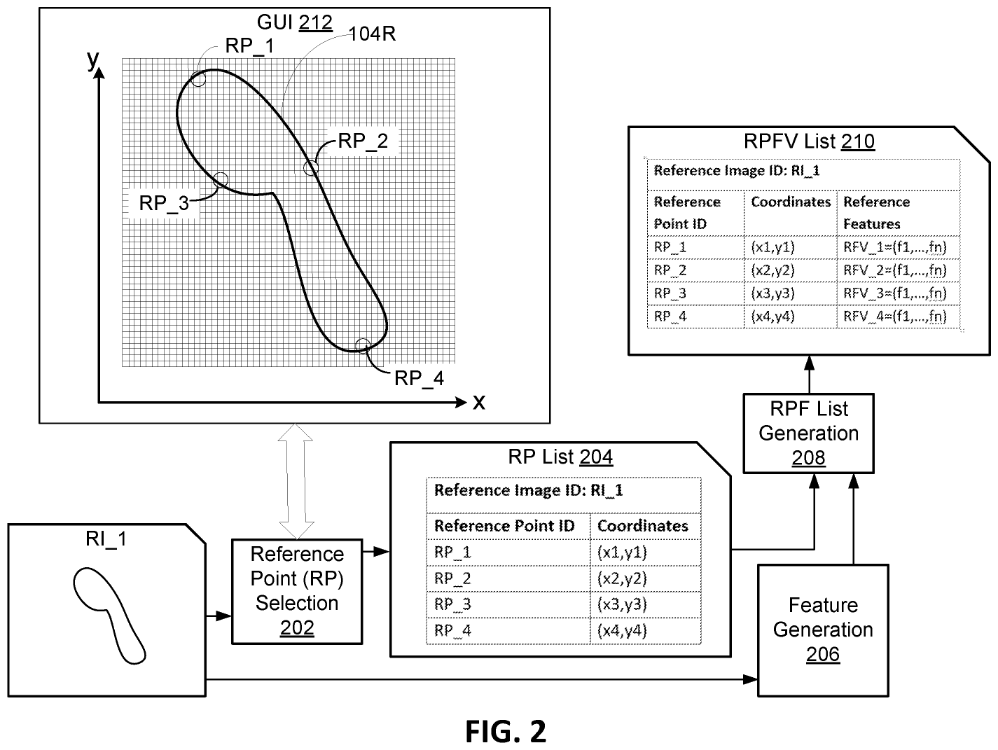

In this regard, FIG. 2 illustrates a flow diagram of operations performed during configuration phase by configuration module 112. During configuration phase, a reference image RI_1 is provided as input for the correspondence module. Reference image RI_1 can, for example, be an image of a reference object 104R in environment 102 that is captured by a camera 108(i) of the system 100 as part of the configuration phase. Alternatively, the reference image RI_1 can be generated by a camera external to the system 100 and provided electronically to the configuration module 112.

Configuration module 112 includes a reference point selection operation 202 that processes the input reference image RI_1 of reference object 104R to select and output a set of one or more reference points (RP list 204) in respect of the reference image RI_1. For example, configuration module 112 can be configured to interact with a human user by means of graphical user interface (GUI) 212, enabling a user to select one or more reference points (RPs) from the reference image R1_1. FIG. 2 illustrates an example scenario where a user has used an input device to interact with GUI 212 that is displayed on a display screen associated with the configuration module 112. The user has manually selected four on-screen locations about a boundary of the reference object 104R, illustrated as reference points RP_1 to RP_Nrp (where Nrp=4). The configuration module 112 maps each of the user selected locations to a corresponding (x,y) pixel coordinate of the reference image R1_1. By way of example, configuration module 112 may use the approximate center pixel of each user selected image location as the pixel coordinates for a respective reference point (RP). The configuration module 112 generates a reference point (RP) list 204, which as shown in FIG. 2 can include an identifier (ID) for the reference image RI_1, along with a list of Reference Point IDs and image coordinates for each of the selected reference points RP_1 to RP_Nrp.

In an alternative example, the reference point selection operation 202 of configuration module 112 may be configured to automatically select the set of one or more reference points (RPs) from the input reference image RI_1. For example, configuration module 112 may be configured to automatically detect a foreground object and a background, and select one or more reference points on the boundary of or within the foreground object according to preconfigured point selection criteria.

The configuration module 112 also includes a feature generation operation 206 that outputs a set of pixel-level feature vectors (FVs) for the input reference image RI_1. In particular, the feature generation operation 206 is configured to submit the input reference image RI_1 to the trained feature generation model 124 that can, for example, be part of the correspondence module 110. The trained feature generation model 124 is a machine learning (ML) based model that has been pre-trained to generate a feature vector (FV) of discriminating features for respective pixels of an input image. As described in detail below, the trained feature generation model 124 has been pre-trained during the training phase with the objective of generating identical feature vectors for image pixels from different images that correspond to identical points of an object that is represented in the different images.

In example implementations, the architecture of feature generation model 124 can be implemented using any suitable feature-generating model such as models that are used in one or more of image processing, computer vision, machine learning, or deep learning applications. As a particular example, the architecture of feature generation model 124 can be based on Dense Object Net (DON) (Peter R Florence, Lucas Manuelli, and Russ Tedrake, “Dense object nets: Learning dense visual object descriptors by and for robotic manipulation”, 2nd Conference on Robot Learning (CoRL 2018), Zurich, Switzerland, 2018), which can generate features per pixel of its input image. For DON, as a particular example, any neural network can be used as the backbone network. Some particular examples are UNet (Olaf Ronneberger, Philipp Fischer, and Thomas Brox, “U-net: Convolutional networks for biomedical image segmentation”, in International Conference on Medical image computing and computer-assisted intervention, pp. 234-241, Springer, Cham, 2015), ResNet (Kaiming He, Xiangyu Zhang, Shaoqing Ren, and Jian Sun, “Deep residual learning for image recognition”, in Proceedings of the IEEE conference on computer vision and pattern recognition, pp. 770-778. 2016), Convolutional Neural Network (CNN), Multilayer Perceptron (MLP), and transformers (Ashish Vaswani, Noam Shazeer, Niki Parmar, Jakob Uszkoreit, Llion Jones, Aidan N. Gomez, Lukasz Kaiser, and Illia Polosukhin, “Attention is all you need”, Advances in neural information processing systems 30, 2017). One of the benefits of UNet as the backbone, for example, is that it can capture both local and global features of the image because of having layers with various sizes.

Accordingly, in an example implementation, feature generation operation 206 provides the reference image R1_1 to trained feature generation model 124 and receives a corresponding feature map that includes a respective feature vector FV for each pixel of the reference image R1_1. Each pixel-level feature vector FV includes a respective set of generated features {f1, . . . , fn}, where n is the number of features (e.g., dimensions) per pixel.

The feature vectors FV generated for the for the pixels of the reference image R1_1 are provided, along with the reference point list 204, to a reference point feature (RPF) list generation operation 208 that selects the feature vectors FV generated in respect of the reference points (e.g., RP_1 to RP_4) that correspond to the pixels identified in the reference point list 204 as reference feature vectors (RFVs). The reference point feature vectors (RFVs) are assembled into a reference point feature vector (RPFV) list 210 that is stored for future use by corresponding point detection operation 126 of the correspondence module 110. As indicated in the illustrative example of FIG. 2, the reference point feature vector (RPFV) list 210 for a reference object 104R can, for example, include an identifier (ID) for the reference image RI_1, along with a list of Reference Point IDs, image coordinates for each of the selected reference points RP_1 to RP_Nrp (which can provide a reference point topography if required) and the respective reference feature vectors RF_1 to RFV_Nrp for each of the reference points RP_1 to RP_Nrp. Each reference feature vector RFV includes respective set of reference features {rf₁, . . . , rfₙ} as generated by the trained feature generation model 124.

In example embodiments, multiple different object types can be processed as respective reference objects (for example, boxes of different sizes and shapes), with a respective set of reference points and reference feature vectors being generated for each object and included in the reference point feature vector (RPFV) list 210.

As described below, in some examples, the trained feature generation model 124 can be trained in a 3D scene learning mode. In scenarios where the reference object 104R has 3D features that are to be considered as part of the correspondence phase, the configuration phase can optionally comprise capturing a set of 2D reference images RI_1, RI_N_ri (where N_ri indicates a number of different camera views) for different camera views of the reference object 104R. In reference point selection operation 202, the respective reference points RP_1 to RP_N_rp that correspond to the same physical locations of the reference object 104R are identified across the set of 2D reference images and a respective RP list 204 generated for each 2D reference image RI_1, RI_N_ri with the respective unique reference point coordinates for each of the reference points RP_1 to RP_N_rp for that particular reference image. The set of 2D reference images RI_1, RI_N_ri can then be provided the feature generation model 206 to generate respective feature maps for each of the 2D reference image RI_1, RI_N_ri. As part of RPF list generation, the corresponding reference features that are generated across the set of 2D reference image RI_1, RI_N_ri can be amalgamated for each reference point to provide a reference feature vector RFV that captures data across multiple 2D-Camera views. For example, the reference feature vectors RFV_1 generated for reference point RP_1 for the set of 2D reference images RI_1, RI_N can be amalgamated (for example averaged) to arrive at a final reference feature vector RFV_1 that is then included in the RPFV list 210. In the case where the trained feature generation model 124 has been trained in a 3D scene learning mode, the reference feature vectors will inherently embed 3D data, and the use of multiple camera views to generate the reference features vectors that are included in RPFV list 210 can provide reference feature vectors that can ultimately be matched to multiple possible views during a correspondence phase.

CORRESPONDENCE PHASE: As indicated above, correspondence phase involves performance of a point correspondence task as part of ongoing real-time process that is carried out in the environment 102.

During the real-time process, a sequence of images of the environment 102 (containing with one or more objects 104) are provided to the correspondence module 110 by one or more of the cameras 108(1) to 108(N). Correspondence module 110 is configured perform a correspondence task that detects and recognizes points in the input images that correspond to the points that are identified in the reference point feature vector list 210. Object instances in the sensed images that correspond to the reference object 104R can be detected and recognized based on the resulting point correspondence data. In example implementations, reliance on the point correspondence data enables correspondence module 110 to detect and recognize corresponding object instances even when the objects being processed have irregular shapes and varying relative poses.

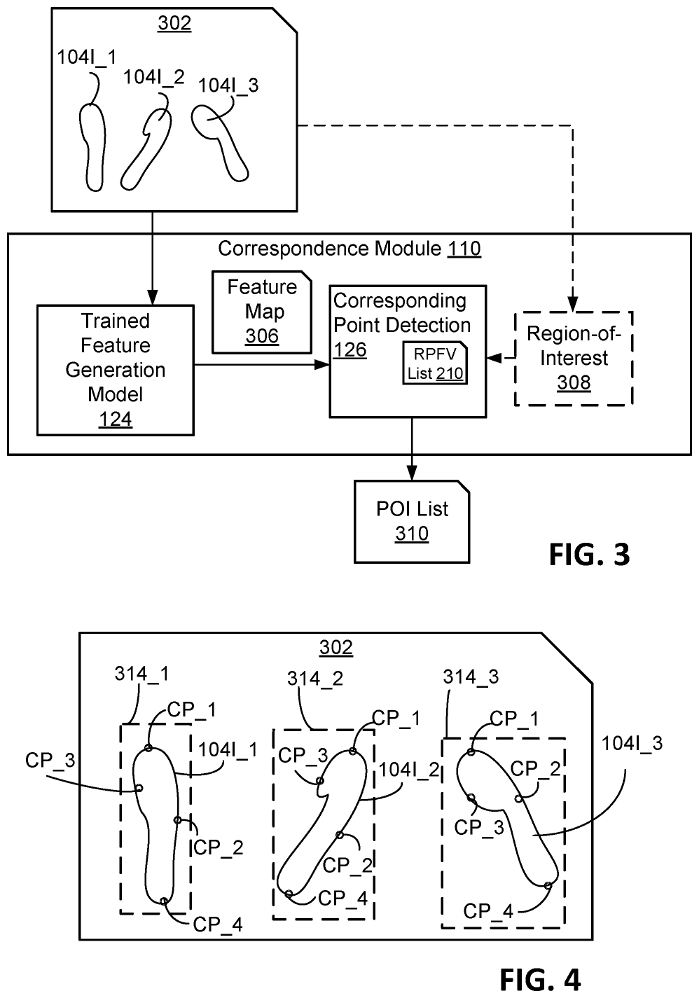

In this regard, FIG. 3 illustrates an example of the correspondence phase operation of correspondence module 110 when processing an input image 302. Image 302, which can be an image in a sequence of images, represents an input image that has been captured by camera 108(i) of an on-going process in environment 102. For example, image 302 may represent a real-world scene of a region of conveyor belt 106 that includes multiple observed mass-processed objects 104 that are the same type of object as (e.g., correspond to) the reference object 104R, but which may vary in size and shape relative to the reference object 104R. For example, the objects 104 may be food products such as chicken parts of different shapes and sizes in a food processing plant. The real world objects 104 are represented in image 302 as object instances 104I_1, 104_2 and 104_3 (referred to generically as object instances 104I) in the illustrated example of FIG. 3.

The image 302 is provided to trained feature generation module 124, which generates a corresponding feature map 306 that includes respective feature vectors FV for each of the pixels of the image 302. Each pixel-level feature vector FV includes a respective set of generated features {f1, . . . , fn}.

The feature map 306 is then provided to a corresponding point detection operation 126 that is configured to detect the points (e.g., pixel locations) in the input image 302 that correspond to reference points that are identified in the reference point feature vector (RPFV) list 210 that was previously generated in respect of reference object 104R. In some alternative examples, corresponding point detection operation 126 can be a discrete rules-based operation or an ML-based model that has been trained to perform a pixel matching task. In some examples, corresponding point detection operation 126 can be implemented as one or more network layers or a kernel of the ML model that is used to implement the trained feature generation model 124.

By way of example, one possible matching operation is a pixel-wise distance operation whereby, for each feature map 306 pixel-level feature vector (FV), a respective distance metric (for example a Euclidian distance) is computed relative to each of the reference point feature vectors listed in reference point feature vector (RPFV) list 210. A corresponding point match occurs when the computed distance metric between a feature map 306 pixel-level feature vector (FV) and a reference point feature vector meets predefined criteria. For example, a corresponding point match can be identified if the computed distance metric falls below a defined threshold value. In situations where up to a specified number (e.g., k) of corresponding point matches are expected, then a corresponding point match can be identified for the k pixels in feature map 306 that have smallest computed distance metrics relative to the reference point feature vector and fall below a defined threshold value. The feature map 306 pixels that are identified as being a corresponding match to a respective reference point feature vector are considered “points-of-interest (POI)” and can be identified in a POI list 310 that is generated in respect of the input image 302.

In some examples, the correspondence module 110 can include a region-of-interest operation 308 that can identify one or more discrete search areas within the feature map 306 that can be used to focus corresponding point detection operation 126. Region-of-interest operation 308 can, for example, be applied in environments such as illustrated in FIGS. 1 and 3, where an input image 302 is expected to include multiple foreground object instances 104I against a background. In example embodiments, the region-of-interest operation 308 is configured to identify respective regions-of interest for discrete object instances 104I in the image 302. By way of illustration, FIG. 4 includes respective regions-of-interest 314_1, 314_2 and 314_3 overlaid as dashed rectangles on image 302 (which maps directly to pixels of feature map 306). Each region-of-interest 314_1, 314_2 and 314_3 encompasses a respective sub-set of image pixels that include a respective object instance 104I_1, 104I_2, and 104I-3.

Region-of-interest operation 308 can be implemented using one or more region-of-interest methodologies. By way of example, in an environment 102 where the background of captured images is consistent, region-of-interest operation 308 can employ a rules-based function or a trained ML based-model for detecting non-background (i.e., foreground) objects and generating bounding boxes around each such objects, thereby defining regions-of-interest 314_1, 314_2 and 314_3. In alternative examples, the relative locations of respective object instances 104I_1, 104I_2, and 104I-3 in an image 302 may be predetermined based on camera location and process constraints, as well as based on information collected from previous imaging or processing operations. In such cases, regions-of-interest 314_1, 314_2 and 314_3 can be pre-defined without any real-time processing.

In examples where regions-of-interest 314_1, 314_2 and 314_3 are provided to the corresponding point detection operation 126, that information can be used to both identify potential discrete object instances 104I and focus the search areas that are used to match pixels from the feature map 306 to reference points defined in the reference point feature vector (RPFV) list 210. By way of example, FIG. 4 graphically illustrates an scenario where the feature map 306 pixel-level feature vectors (FVs) that are fall within region-of-interest 314_1 are searched by corresponding point detection operation 126 to identify any matches with reference point feature vector (RPFV) list 210. Similar to the image-wide search methodology described above, such search can be based on identifying the pixel-level feature vectors (FVs) for the pixels within the region-of-interest 314_1 to identify those that have the closest distance metric to the respective reference point feature vectors. In the illustrated example of FIG. 4, the corresponding point CP_1 indicated in region-of-interest 314_1 is identified as a corresponding point match for reference point RP_1. Similarly, points CP_2, CP_3 and CP_4 indicated in region-of-interest 314_1 are identified as corresponding point matches for reference points RP_2, RP_3 and RP_4, respectively. Thus, corresponding points CP_1, CP_2, CP_3 and CP_4 are all points-of-interest within region-of-interest 314_1. The search is repeated for the other identified regions-of-interest (e.g., ROI 314_2 and 314_3) with matching corresponding points (e.g., CP_1, CP_2, CP_3 and CP_4) also being identified in those regions. Information indicating the corresponding points/points-of-interest are included in the POI list 310 that is generated in respect of input image 302.

By way of example, the POI data included the POI list 310 can include, among other things, one or more of: Reference Object ID; Reference Point IDs; Input Image ID; Unique ID for each object instance (and/or region-of-interest) in the input image 302; List of corresponding point pixel coordinates in the input image 302 for each of pixels matched to a respective reference point. An example of this POI data is illustrated in the following illustrative table 1:

TABLE 1
Example of POI List 310

| Reference | Input Image ID: 302 | | |
|---|---|---|---|
| Object | Object Instance | Object Instance | Object Instance |
| ID: 104R | 104I_1 | 104I_2 | 104I_3 |
| Reference | Corresponding | Corresponding | Corresponding |
| Point ID | Point | Point | Point |
| RP_1 | CP_1 = (x1, y1) | CP_1 = (x5, y5) | CP_1 = (x9, y9) |
| RP_2 | CP_2 = (x2, y2) | CP_2 = (x6, y6) | CP_2 = (x10, y10) |
| RP_3 | CP_3 = (x3, y3) | CP_3 = (x7, y7) | CP_3 = (x11, y11) |
| RP_4 | CP_4 = (x4, y4) | CP_4 = (x8, y8) | CP_4 = (x12, y12) |

Other POI data that can be included in the POI list can include, for example, the coordinates defining the respective regions-of-interest 314_1, 314_2, 314_3 that correspond to the respective object instances 104I1, 104I_2, 104I_3. In examples, as the relative pose and locations of the cameras are known within the environment 102, as well as data for any relevant dynamic elements (e.g., a moving conveyor belt) of the environment 102, the corresponding point coordinates for input image 302 can be mapped to a real-time physical location within the environment 102, and coordinates for the physical location can be included in the PPI list 310 or determined at a later stage from the data included in the POI list 310.

In some examples, the distance metric applied by the corresponding point detection operation 126 to identify matching corresponding points can be based on more than just the feature vectors generated for solitary pixels of the input image. For example, data from the feature vector for a subject pixel can be fused with corresponding data from feature vectors of its neighboring pixels, and the distance metric (for example a Euclidian distance) could be based on the fused feature vector. In at least some examples, different weighting values can be applied to the features of the subject pixel and the features of sampled neighbor pixels to determine the fused feature vector for a subject pixel. In some examples, these weighting values may be manually predefined. In some examples, these weighting values may be learned using ML learning techniques. In some scenarios, the use of a fused feature vector can enable or enhance a consideration of the pixel features surrounding the subject pixel to also be taken into account when determining a corresponding point match. In at least some examples, the reference point feature vectors themselves can similarly be fused feature vectors that are determined based on a weighted fusing of features of the selected pixels of the reference image RI_1 with their neighboring pixels.

In example embodiments, the POI lists 310 generated by correspondence module 110 can be used for a number of real-time processing operations in the environment 102. For example identification and recognition information that is inherent in the POI data can be used to determine object location and pose in the environment 202. This information, combined with predetermined knowledge of the process and environment 202 can be used to track the objects 104 throughout parts of the process. The relative locations of the corresponding points for a particular object instance 104I can be used for quality checks of the represented object 104. With reference to FIG. 1, data derived from POI lists 310 can be used by a control module 118 to cause one or more robotic effectors 136 to perform actions (e.g., pick or selection or other processing actions) in respect of one or more of the objects 104.

In this regard, the correspondence imaging system 100 can be used in various applications to implement a live detection, recognition and tracking imaging system that is able to detect, recognize, and track objects (including moving objects) for various goals such as pick-and-place, pick-and-pack, singulate-and-sort, and visual quality control.

In some examples where the trained feature generation model 124 has been trained using 3D scene learning mode and the object 104 of interest 104 has relevant 3D features, multiple 2D images 302 may optionally be captured representing multiple camera views of the same scene, object 104 or set of objects 104 in order to provide a data about a 3 rd spatial dimension (e.g., depth). In some examples, the multiple images may be captured by (i) the same camera 108(1) moved from one location to another location; (ii) the same camera 108(1) while the object is moved (for example by a conveyor at a known speed); and/or (iii) by multiple cameras 108(1) to 108(N). In example embodiments, location and pose data for the cameras(s) is known or tracked so as to enable physical locations within the scene to be mapped to pixel locations within the respective images and across the images.

In a multiple camera view example, each of the respective camera view images 302 (or each region-of-interest 314-1, 314_2, 314_3 in the case where images are segmented by region-of-interest operation 308) can be respectively processed by trained feature generation module 124 to generate a respective view-specific feature map 306, with each view-specific feature map 306 embedding data about a 3 rd spatial dimension (e.g., depth). Corresponding point detection operation 126 can be configured to combine information from the view-specific feature maps 306 to generate POI list 310. For example, the feature vectors for pixels that map to common physical locations in a captured scene may be averaged across the view-specific feature maps 306 to provide average feature vectors that can then be compared to the reference feature vectors included in RPFV list 210, with a resulting POI list 210 being generated based on matching the average feature vectors to corresponding reference feature vectors. In other examples, the feature vectors for pixels that map to common physical locations from each of the multiple camera view images may each be independently compared to the reference feature vectors included in RPFV list 210 to identify points of interest in each of the multiple view images 302, with the POI lists for each set of multiple view images then used to generate a final POI list 310 for the set of multiple view images. For example, a majority vote algorithm could be applied for the set of multi-image data to identify the most likely POIs for inclusion in POI list 310.

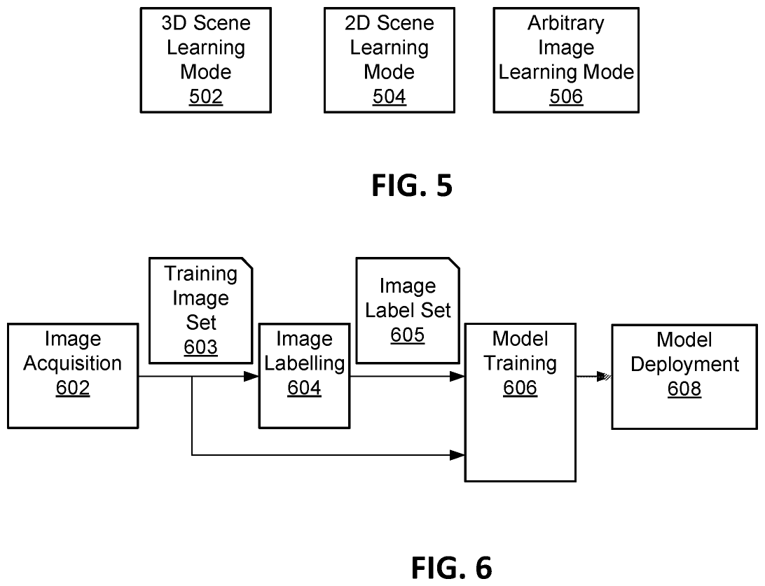

TRAINING PHASE: As noted above, in example implementations, training phase involves initially training and then periodically updating or retraining training phase feature generation model 142 for subsequent deployment to the correspondence module 110 as trained feature generation model 124. In example implementations, the system 100 can be selectively trained using different types of learning modes. In some examples, learning module 116 provides a user set-up interface that allows an authorized user to select which type of learning mode is applied to prepare a feature generation model for deployment to correspondence module 110. The particular learning mode that is used can be selected based on the specific application that the system 100 will be used for when it operates during correspondence phase. By way of example, FIG. 5 illustrates three possible learning modes that can be selected, namely a 3D scene learning mode 502, a 2D scene learning mode 504 and an arbitrary image learning mode 506. Each of these respective learning modes can be used to support a respective type of operational mode during the correspondence phase.

As will be explained in greater detail below, 3D scene learning mode 502 and 2D scene learning mode 504 each rely on images of scenes that are captured by one or more cameras 108(i) in the real-world environment 202 (or similar domain) that the system 100 operates in. However, arbitrary image learning mode 506 can be used to train the system 100 using images from scenes that can be from a different domain or context than that of environment 202.

With reference to FIG. 6, each of these respective learning modes include the following operations: an image acquisition operation 602 to acquire a training image set 603 of training images that will be used for training a training mode feature generation model 142; an image labelling operation 604 to automatically label corresponding points across multiple corresponding image sets that are included in the training image set 603 to create or augment a labelled image dataset 605; a model training operation 606 to train or update a feature generation model 142; and a model deployment operation 608 that deploys the trained or updated feature generation model to correspondence module 110 for use as the trained feature generation model 124. These operations are described below in respect of each of the learning modes.

3D SCENE LEARNING MODE: The 3D scene learning mode 502 can be used when the system 100 will be applied in a 3D operational mode, for example when the system 100 will be applied in an environment 102 in which the objects-of-interest to be processed during the correspondence phase have a 3D structure and that 3D structure is relevant to one or more aspects of the object processing in the environment. Examples of such an environment 102 can include an industrial process where boxes are moved on a live conveyor in a factory. In such a scenario, the system 100 can be used to detect and track the (possibly moving) boxes on the conveyor. Another example can be an office environment where the objects-of-interest have various heights and widths and the system 100 will be used to detect and recognize the objects.

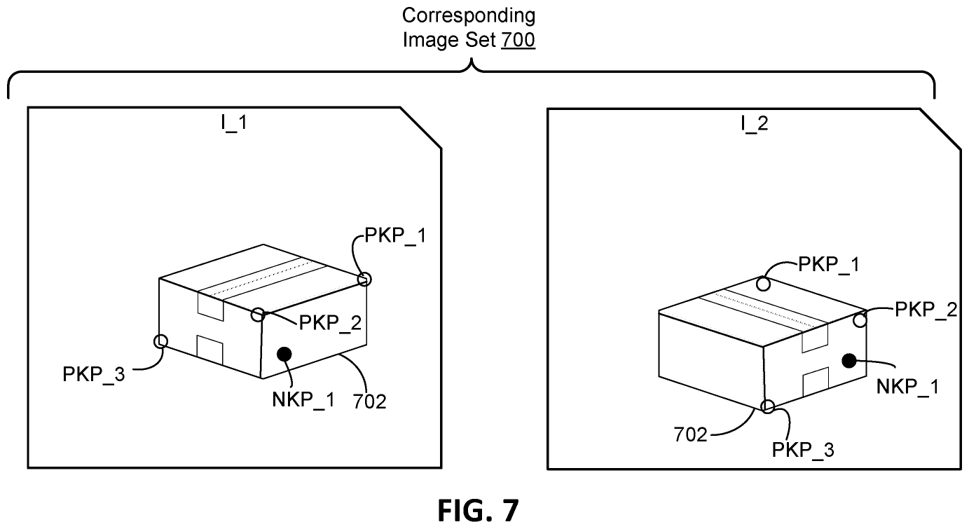

Image acquisition operation 602: In an example embodiment, in the 3D learning mode, the image acquisition operation 602 can be performed by the logging module 114 working in cooperation with one or more cameras 108(i) to capture a training image set 603 that is made up of multiple corresponding image sets 700 (see FIG. 7). A corresponding image set 700 includes multiple images (e.g., at least a pair of images) that each include at least portions (regions-of-interest) of an identical scene such that at least some of the same observed points in the scene are included at different pixel locations in the multiple images. In this regard, the corresponding image set 700 represents multiple camera views of a scene or object or set of objects, thus enabling 3D data to be obtained from a set of 2D images. These corresponding image sets 700 are saved as part of the training image set 603 by the logging module 114, together with metadata that specifies relative position of each participating camera 108(i) to a common reference location within the scene being observed and captured, along with the camera properties of each camera 108(i). The relative position data for each camera 108(i) can, for example, indicate a distance of the camera lens from the common reference location and a camera pose (e.g., angular orientation relative to 3-dimensional axis reference point for the camera). Prior to collecting images, the system 100 can be calibrated by capturing a series of images by each participating camera 108(i) of a reference pattern (for example a checkerboard pattern) that includes the reference location in the environment 102.

FIG. 7 shows an example of a corresponding image set 700 that includes first and second images I_1 and I_2 that both include portions of an identical scene captured from two different known camera locations and poses (e.g., two different camera views). In some examples, the same camera 108(i) may be moved from one known location to another known location to capture the same observed scene. In other examples, different cameras (e.g., camera 108(1) and 108(N)) in respective known locations and poses relative to the observed scene can be used to capture the first and second images I_1 and I_2 respectively. In the example of FIG. 7, a 3D object 702 (e.g., an object-of-interest such as a sealed packing box) is included in the scene, and is shown from two different perspectives in the first and second images I_1 and I_2. The system 100 is preconfigured such that relative location and pose of the camera(s) 108(i) capturing the first and second images I_1 and I_2 relative to the 3D object 702 at the time of the image capture is known and stationary, such that the pixel location of key-point (e.g., KP_1) of the object 702 in the first image I_1 can be computationally mapped to the pixel location of the identical key-point (e.g., KP_1) in the second image I_2 and vice versa. For example, the images may be captured at a time when the 3D object 702 is stationary at a processing or inspection station in the environment 102.

In the illustrated example, the corresponding image set 700 includes multiple images of a scene that each include the identical object 702 (e.g., the same box from different viewing perspectives). The training image set 603 is a set of multiple corresponding image sets 700. Although the same object 702 is the subject of each corresponding image set 700, each corresponding image set 700 can be of a different respective object such that multiple objects are represented in the training image set 603. In example embodiments, the different objects that are the subject of different training image sets 603 can be the same type or class of object (e.g., a set of mass produced or mass processed objects that are preprocessed in the environment 102 over a training image acquisition period), which can enable feature generation model 142 to learn domain-specific information that can cover a range of object variations and process variations (e.g., changes in object position and orientation, and factors such as camera positioning and lighting, over time).

In some example embodiments, the image acquisition operation 602 is performed by the logging module 114 at a location of environment 102, and the resulting training image set 603 is uploaded to a data storage 138 element of learning module 116 upon occurrence of a predetermined upload-triggering event. By way of example, the predetermined upload-triggering event could include, among other things, one or more of: a manual upload request by an human operator; detection of a passage of a preconfigured amount of time; detection of logging of a preconfigured volume of images; detection of logging of data over a preconfigured number of industrial cycles; and detection of a change in one or more predefined process parameters. In some examples, the training image set 603 images that are uploaded from logging module 114 to data storage 138 can be subsequently deleted or overwritten form the local storage used by the logging module 114 if the storage space is required.

In at least some examples, data storage 138 can receive and amalgamate training image sets 603 from multiple environments 102 and/or multiple industrial processes. For example, a commercial entity may have multiple processing environments 102 located at the same site or at different sites that are all performing a similar types of industrial process resulting in multiple logging modules 114 capturing respective training image sets 603. The multiple training image sets 603 can be combined into a common amalgamated training image set 603 at data storage 138.

In at least some examples, logging module 114 can also be used to log other data from the environment 102 that is collected simultaneously with the images that are acquired by cameras 108(i). For example, if the environment 102 includes robotic or mechanical devices, time-stamped states of such devices can be logged over the duration of a process, including, but not limited to: position of joints, temperature, pressure, motion success flags, and controller states of any control systems. In examples where the logging module 114 is collecting information in an environment 102 that includes a previously deployed trained feature generation model 124 then the POI lists 310 generated in respect of a current process could also be logged by the logging module 114. This additional data can also be provided with the training image set 603 to the learning module 116 for use in training or updating the training phase feature generation model 142.

Image Labelling Operation 604: In the illustrated example, the learning module 116 includes a training data labeler 140 for performing image labelling operation 604. Image labelling operation 604 involves generating training labels for each of the corresponding image sets 700 that are included in the training image set 603. The image labelling operation 604 can be triggered by a predetermined labelling-triggering event that can, for example, be similar to the trigger events noted above in respect of the upload-triggering event.

Image labelling operation 604 is configured to identify groups of corresponding positive key-points and corresponding negative key-points across the images included in a corresponding image set 700 to provide a respective corresponding key-point list for the corresponding image set 700. Corresponding positive key-points within positive key-point group are identical or nearly identical points in a scene that are captured in the multiple images of the corresponding image set 700. By way of example, in FIG. 7, the key-point labelled PKP_1 in image I_1 and the key-point labelled PKP_1 in image I_2 each correspond to a same identical or nearly identical point of the 3D object 702, as captured from two different relative camera positions. Thus, the point PKP_1 from image I_1 and point PKP_1 from images I_2 collectively provide a first group of corresponding positive key-points. The (x,y) pixel coordinates corresponding to a center of these points in each image can be used as an index to identify the respective locations of the points in each image of the corresponding image set 700. FIG. 7 also illustrates second and third groups of corresponding key-points, namely the points labelled PKP_2 in images I_1, I_2 and points labelled PKP_3 in images I_1, I_2, respectively.

Corresponding negative key-points are points that are captured in the multiple images of the corresponding image set 700 that are confirmed to be non-identical points. Corresponding negative key-points groups can include one or more of different points of an object or of a background across the multiple images. By way of example, in FIG. 7, the key-point labelled NKP_1 in image I_1 and the key-point labelled NKP_1 in image I_2 each correspond to a respective different point of the 3D object 702, as captured from two different relative camera positions. Thus, the point NKP_1 from image I_1 and point NKP_1 from images I_2 collectively provide a first group of a corresponding negative key-points.

By way of example, Table 2 below illustrates a possible format of a corresponding key-point list for the corresponding image set 700 of the training image set 603.

TABLE 2
CORRESPONDING KEY-POINT LIST FOR
THE CORRESPONDING IMAGE SET 700

| | Key-point | | | |
|---|---|---|---|---|
| | Group | Image I_1 | Image I-2 | . . . |
| Positive | Group P1 | PKP_1 = (x1, y1) | PKP_1 = (x5, y5) | |
| Key-points | Group P2 | PKP_2 = (x2, y2) | PKP_2 = (x6, y6) | |
| | Group P3 | PKP_3 = (x3, y3) | PKP_3 = (x7, y7) | |
| Negative | Group N1 | NKP_1 = (x4, y4) | NKP_1 = (x8, y8) | |
| Key-points | | | | |

As indicated in the above table, the corresponding key-points are mapped by their respective pixel coordinate locations across the multiple images included in corresponding image set 700.

The key-point lists generated in respect of each of the corresponding image sets 700 included in the training image set 603 collectively provide an image label set 605 for the training image set 603. The sets of corresponding positive key-points provide positive-outcome labelling examples for training the Training Phase Feature Generation Model 142. Similarly, the sets of corresponding positive key-points provide negative-outcome labelling examples for training the Training Phase Feature Generation Model 142. In some examples, the number of positive key-points and the number of negative key-points to generate for each of the image sets 700 can be a predefined parameter.

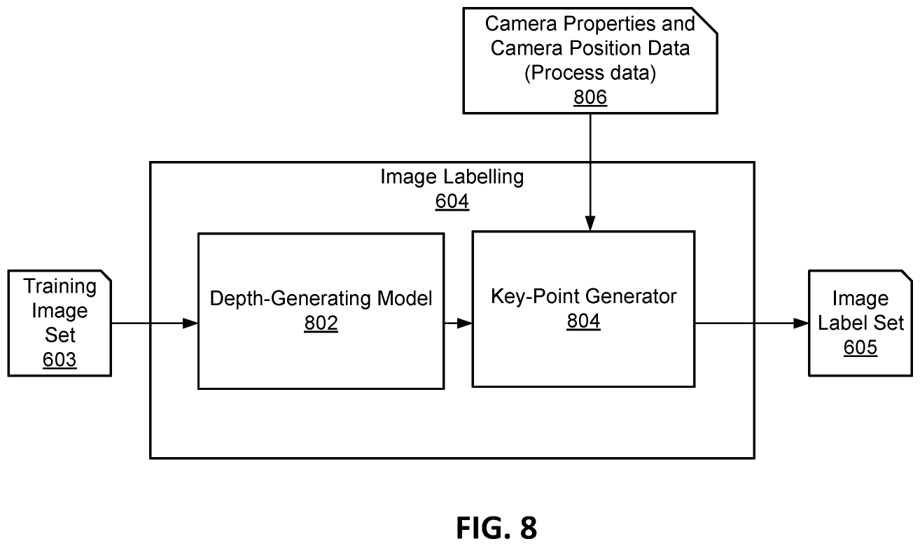

With reference to FIG. 8, in the case of the 3D scene learning mode, the image labelling module 604 can include a machine learning (ML) based depth-generating model 802 that is trained to generate depth information for the images included in the training image set 603. As noted above, in example embodiments, cameras 108(1) to 108(N) are conventional 2D imaging device that generate 2D image data (e.g., 3 channel RGB or HIS image data or 1 channel greyscale image data). Depth-generating model 802 can be configured to generate an extra channel of data for each pixel, namely a depth value that represents a 3 rd spatial dimension for each of the pixels represented in a 2D image array. Any suitable depth-generating model can be used that is able to extract depth information from multiple 2D camera views. For example, depth-generating model 802 can be any suitable neural rendering model. As a particular example, Neural Radiance Field (NeRF) (Ben Mildenhall, Pratul P Srinivasan, Matthew Tancik, Jonathan T Barron, Ravi Ramamoorthi, and Ren Ng, “NeRF: Representing scenes as neural radiance fields for view synthesis”, in European conference on computer vision, pages 405-421, Springer, 2020) can be used, as a neural rendering model, for generating the depth of objects in a 3D scene.

The depth information that is provided by the trained depth generating model 802 in respect of the images included in the training image set 603, together with the camera properties and camera position data of the one or more camera(s) 108 that were used to capture the images, are provided to key-point generator 804. Based on these inputs, key-point generator 804 is configured to identify and map corresponding key-points across the multiple images included each corresponding image set 700 to generate a corresponding key point list for each corresponding image set 700. In some examples, key-point generator 804 can be implemented by a pre-trained ML model or rules-based model, or combinations thereof, that is configured to identify regions of interest (e.g., key areas of an object represented in the image) for selecting points to use as corresponding positive key points.

Model Training Operation 606: Referring again to FIG. 6, the training image set 603 and the image label set 605 are used as a labelled training data set by model training operation to train training phase feature generation model 142 (or update a previously trained model). For example, for each corresponding image set 700, the feature generation model 142 can be used to generate respective feature maps for each of the multiple images included in the corresponding image set 700. In the case of 3D scene learning mode, the data that is input to feature generation model 142 can include the 3-channel 2D pixel level image data (e.g., 3 channel RGB or HIS image data or 1 channel greyscale image data), together with an additional channel of per-pixel depth data generated by depth-generating model 802. As noted above, a feature map can include a respective feature vector FV for each pixel of the image it is generated in respect of. The training objective is to train the feature generation model 142 to generate identical or nearly identical feature vectors for image pixels from the different images that correspond to the corresponding positive key-points, and to generate very dissimilar feature vectors for image pixels from the different images that correspond to the corresponding negative key-points.

Accordingly, the corresponding positive key-points in the images of a corresponding image set 700 should have similar or closely similar features in the generated feature space, and the features of the corresponding negative key-points should be dissimilar. During the training phase, the feature generation model 142 learns to push the features of positive key-points towards each other and pull the features of the negative key-points away from one another. This can be performed by applying any suitable optimization procedure during the training phase. For example, if the feature generation model 142 is a neural network, such as the Dense Object Net (DON) noted above, its loss function pushes the features of positive key-points together and pulls the features of negative key-points away. As particular examples, a variety of triplet loss functions, contrastive loss functions, classification loss functions, and neighborhood embedding loss functions can be used for this purpose.

Model Deployment Operation 608: Once the training phase feature generation model 142 is trained (or updated), the model can be deployed to replace the trained feature generation model 124 for real-time use by the correspondence module 110.

2D SCENE LEARNING MODE 504: The 2D scene learning mode 504 can be used when the system 100 will be applied in a 2D operational mode, for example when the system 100 will be applied in an environment 102 in which the objects-of-interest to be processed have a structure that can be identified and tracked based on two dimensional analysis, for example based on object width and length without reference to object height. By way of example, objects that have 3 rd dimension size characteristics that are less distinguishing of the object than the dimensions in the further two spatial dimensions, can be suitable for 2D scene learning mode 504. Such objects can for example, include objects that are relatively flat (e.g., have a small height dimension relative to their length and width dimensions) such as candy canes or chocolate bars or other low-profile objects. The operations performed for 2D scene learning mode 504 are substantially similar to those performed for 3D scene learning mode except that aspects of the image acquisition operation 602 and image labelling operation 604 can be simplified as depth information does not need to be taken into account.

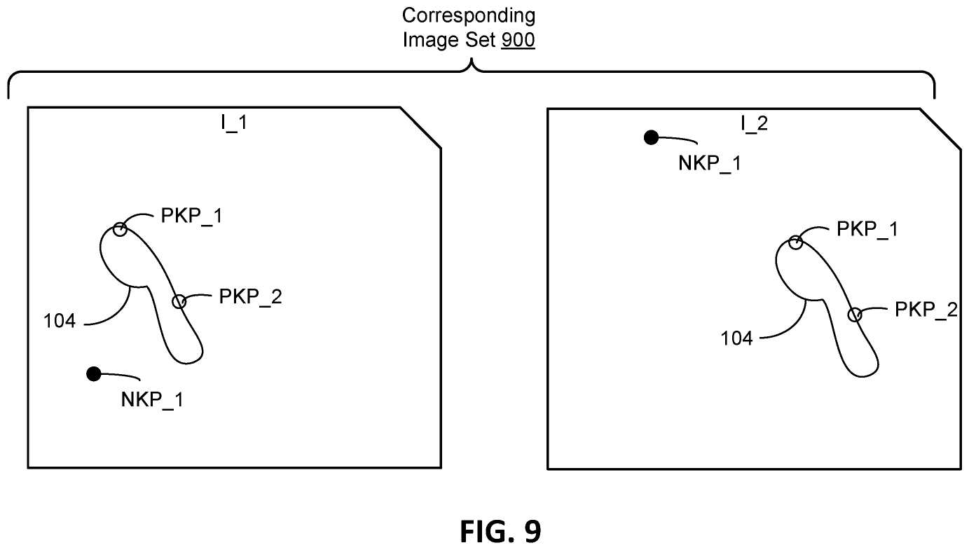

Image acquisition operation 602: The 2D learning mode image acquisition operation is similar to that of the 3D learning mode except for the following differences that will be described with reference to FIG. 9. As with 3D learning mode, in the 2D learning mode, the image acquisition operation 602 can be performed by the logging module 114 working in cooperation with one or more cameras 108(i) to capture a training image set 603 that is made up of multiple corresponding image sets 900 (see FIG. 9). In the illustrated example, the corresponding image set 900 is captured by a single camera 108(i) as low-profile object 104 is moved through the environment 102 at a known speed (e.g., by a constant speed conveyer belt). Each of the images I_1, I_2 is captured when the object 104 is a different location with the field-of-view of the camera 108(i). The stationary camera position combined with the known rate of speed enables the pixel locations of corresponding positive key-points points of the object 104 to be easily tracked across the multiple images of the corresponding image sets 900. These corresponding image sets 900 are saved as part of the training image set 603 by the logging module 114, together with the rate-of-speed that the subject objects are moving at. In the case where multiple cameras 108(i) are used to capture images, the relative position of each participating camera 108(i) to a common reference location within the scene being observed and captured, along with the camera properties of each camera 108(i) can also be stored as metadata.

Image Labelling Operation 604: The 2D learning mode image labelling operation 604 can be simplified relative to that of the 3D learning mode as there is no requirement for a depth-generating model 802 as the key-point generator 804 can perform key-point mapping without requiring depth information. In this regard, the key-point generator 804 can be implemented as a hindsight labeler in this mode that receives training image set 603 as an input, together with the process data 806 that includes information (e.g., conveyor belt speed) that allows the relative position of the object 104 in each of the images I_1, I_2 to be computed. In the example of FIG. 9 where the object 104 is moving in the scene, two images I_1 and I_2 of the same object can be considered, before and after some movement. If the amount and direction of movement are known or measured, the key-point generator 804 can map the relative pixel-locations of the same point (e.g., PKP_1) of the object, before and after the movement, in images I_1 and I_2, respectively. These two points are corresponding positive key-points because they are the same point on the object 104. Multiple corresponding positive key-points can be identified and mapped across the multiple images of corresponding image set 900 by considering multiple same points before and after the movement. This process can be performed for multiple objects within a scene to increase the amount and diversity of corresponding positive key-points for a corresponding image set 900. Moreover, multiple amounts of movement(s) (e.g. more than the one movement shown in FIG. 9) can be considered to generate multiple (e.g., more than two images) and more than two key-points in a group of corresponding positive key points. Any two points in the scene which are not corresponding positive key-points can be considered as negative key-points (e.g., NKP_1 in images I_1 and I_2), either if they are across several images taken with intervening movement or if they are from the same image.

Based on such mapping the image labelling operation 604 generates corresponding key-point lists for the corresponding image sets 900 to provide an image label set 605 for the input training image set 603.

Model Training Operation 606/Model Deployment Operation 608: the model training operation 606 and model deployment operation 608 of the 2D scene learning mode 504 can be identical to that of the 3D scene learning mode 502

ARBITRARY IMAGE LEARNING MODE 506: As noted above, arbitrary image learning mode 506 can be used to train the system 100 using images from scenes that can be from a different domain or context than that of environment 202. Arbitrary Image Learning Mode 506 can, among other things, be used for an initial training of system 100 when actual environment 102 and process specific imaging data has not yet been obtained.

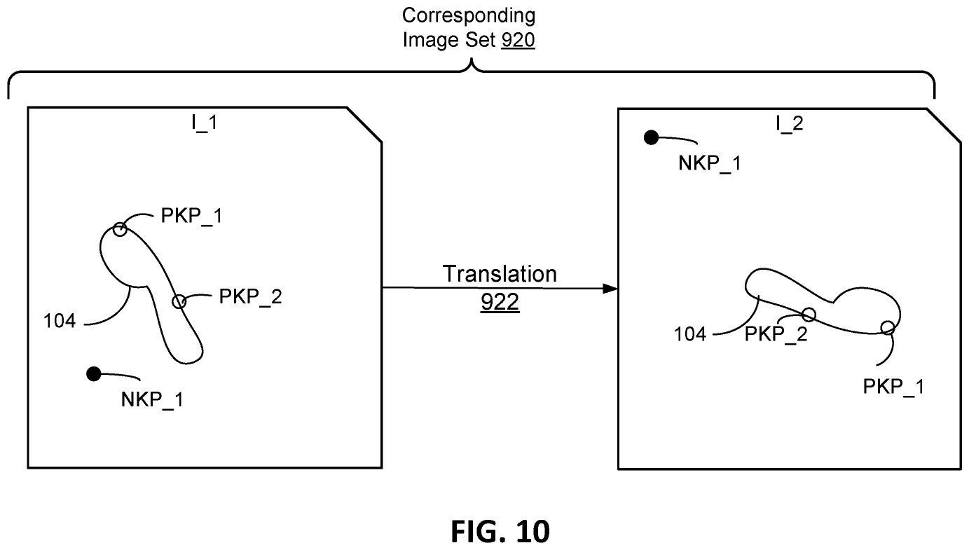

Image acquisition operation 602: Arbitrary image learning mode 506 does not require access to images captured by cameras 108 in environment 102. Rather, input images can be obtained from any source. Each input image can then be manipulated to generate one or more additional virtual images of different perspectives of common scene to generate a corresponding image set. The corresponding image set will includes common scene points located at different pixel locations across the multiple images of the set, and these points can serve as corresponding positive key-points. By way of example, FIG. 10 illustrates an example of a corresponding image set 920. The image I_1 of an object 104 is obtained from a source of arbitrary images. Image acquisition operation 602 applies a translation 922 to image I_1 to obtain corresponding image I_2 in which the location and orientation of the scene foreground content (e.g., an instance of object 104) has been shifted and rotated, respectively. The translation parameters that have been applied can be stored as metadata, thus enabling inter-image mapping of the pixel locations that correspond to identical scene points. Multiple translations can be performed to expand the number of images included in each corresponding image set 920. In example embodiments, the translation parameters may be randomly determined within defined parameters. The transformation can be any continuous transformation. Some particular examples of the transformation can be perspective transformation, continuous warping, affine transformation (including translation and/or rotation), and scaling (zooming in/out). Another possible example is the cut-and-paste operation where the object/region of interest is cropped from the image and then pasted in some other image or pasted in some other location of the same image. The corresponding points inside the cropped region of interest before and after pasting can be positive keypoints. It is possible to use multiple continuous transformations together.

These corresponding image sets 920 are saved as part of the training image set 603 by the logging module 114, together with the translation parameters.

Image Labelling Operation 604: The arbitrary image learning mode image labelling operation 604 can be the same as that of the 2D learning mode, except that the translation parameters, rather than physical object movement data, are used by the key-point generator 804 to map pixel locations for key-points between images within a corresponding image set 920.

Based on such mapping the image labelling operation 604 generates corresponding key-point lists for the corresponding image sets 920 to provide an image label set 605 for the input training image set 603.

Model Training Operation 606/Model Deployment Operation 608: the model training operation 606 and model deployment operation 608 of the arbitrary image learning mode 506 can be identical to that of the 2D scene learning mode 504 and 3D scene learning mode 502

In some implementations for any of the leaning modes, it is possible to mask the image foreground (e.g., regions of interest that correspond to one or more objects) to get training key-points (e.g., corresponding positive key-points) only from the foreground. For this, the images can be masked using any technique, such as image processing methods, image segmentation methods, computer vision methods, machine learning methods, or manual methods. For example, if the object has sufficient contrast with respect to the background, the HSV (Hue, Saturation, Value) color channels can be used for separating the foreground from background. Another possible example is to use any computer vision and/or machine learning module to segment the foreground from background. It is also possible to mask and select the objects manually by user input through an interface.

Overview: By way of overview, in an example implementation, operation of system 100 is as follows. A feature generation model 142 is trained during a training phase that includes image acquisition operation 602, image labelling operation 604, model training operation 606 and model deployment operation. During the image acquisition operation 602, a training image set 603 is generated that includes multiple corresponding image sets 700, 900 or 920. Each corresponding image set 700, 900 or 920 includes a set of non-identical images. A plurality of same image points (e.g., points that correspond to the same physical point of an observed object or the same physical point within an observed scene) are represented at different pixel locations across the multiple non-identical images such that a set of same key-points (e.g., points that are identical or substantially identical) are represented across the set of images. In one or more learning modes, the training image set 603 is based on real images acquired by one or more cameras 108 from an environment 102 in which the system 100 is to be applied. In one or more other learning modes, the training image set 603 is based on arbitrary images that are then manipulated using image transformations.

An image labelling operation 604 is then applied to label the training image set 603. In particular, the same key-points are identified across the multiple images included in each corresponding image set 700, 900 or 920, and a corresponding key-point list is generated that maps the same region-of interest key-points by image pixel location across the multiple images. The same region-of interest key-points provide corresponding positive key-point samples for training purposes. The image labelling operation 604 can also identify corresponding negative key-points (e.g., points in the images that are known to be different points) across the images to provide corresponding negative key-point samples for training purposes.

The training image set 603 and generated image label set 605 are then used to train a training phase feature generation model 142. In particular, the feature generation model 142 is trained with the objectives of: (i) generating identical or similar feature vectors for the respective pixels from different images that map to the same corresponding positive key-points; and (ii) generating dissimilar feature vectors for the respective pixels from different images that map to the corresponding negative key-points.

Once the training phase feature generation model 142 is trained it can be used as a trained feature generation model 124 of the correspondence module 110.

During a configuration phase, configuration module 112 and correspondence module 110 are used to generate a reference point feature vector list 210 based on or more reference images. The reference point feature vector list 210 includes feature vectors that are generated by trained feature generation model 124 for pixels in the reference image(s) that correspond to selected reference points of a scene represented in the reference image(s).

During a correspondence phase, images (for examples images collected by one or more cameras 808(i) within the environment 102) are provided to the correspondence module 110 where each image can be processed as follows: trained feature generation model 124 can be used to generate a feature map 306 of pixel-level feature vectors for the image; the feature map 306 is then searched using corresponding point detection operation 126 to determine pixel locations having feature vectors that match reference point feature vectors in the reference point feature vector list 210. Identified matches are then output as points-of-interest in a point-of-interest list 310 generated for the image.

The system 100 can continuously log images captured during an on-going process, and the newly logged images can be periodically used to repeat the training phase to update the training phase feature generation model 142 for redeployment as updated trained feature generation model 124. The periodic updates can enable the system 100 to adapt if the behavior of a process in the environment 102 changes suddenly or gradually.

The system 100 can be used for various applications. For example, it can be used for object detection. For object detection applications, the reference image(s) used during the configuration phase should contain the object-of-interest and several reference points should be selected on the boundary and/or the interior of the object or both.

The system 100 can be used to detect the points-of-interest in images that are video image frames. If the found points-of-interest have similar features to the reference features above an acceptable threshold, then the object is detected in the frame. Another possible criterion for checking if the object is detected in the frame is to check the relative positions of the detected points of interest. If their relative positions are similar to the relative position of the reference points (e.g., if they form a triangle with some specific angles), then they can be deemed to be the key-points of the detected object.

Another possible application of system 100 is object tracking. For this, the reference image should contain the object-of-interest and several reference points should be selected on the object. Detecting the object in the successive frames of an input video can result in tracking the object of interest.

Another possible application of the system 100 is object recognition. For this, multiple reference images can be used, each of which contains an object-of-interest. Several reference points can be selected on the objects. Every object can be detected in the input image/frame. By comparing the similarity scores of generated feature vectors, it is possible to find which one of the objects in the reference images is the most similar to the object of the input frame. In this way, the type of object in the input image/frame can be recognized.

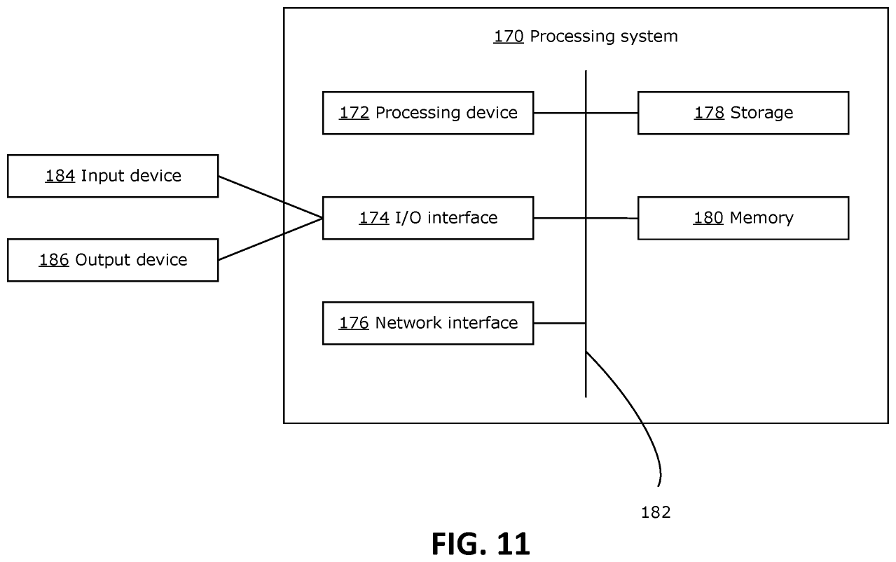

FIG. 11 is a block diagram of an example processing system 170, which may be used as a hardware processing circuit that can be combined with software instructions to implement one or more of the modules and operations of system 100. Other processing systems suitable for implementing embodiments described in the present disclosure may be used, which may include components different from those discussed below. Although FIG. 11 shows a single instance of each component, there may be multiple instances of each component in the processing unit 170.

The processing system 170 may include one or more processing devices 172, such as a processor, a microprocessor, a general processor unit (GPU), a hardware accelerator, an application-specific integrated circuit (ASIC), a field-programmable gate array (FPGA), a dedicated logic circuitry, or combinations thereof. The processing system 170 may also include one or more input/output (I/O) interfaces 174, which may enable interfacing with one or more appropriate input devices 184 and/or output devices 186. The processing system 170 may include one or more network interfaces 176 for wired or wireless communication with a network (e.g., with networks 120 or 122).

The processing system 170 may also include one or more storage units 178, which may include a mass storage unit such as a solid state drive, a hard disk drive, a magnetic disk drive and/or an optical disk drive. The processing unit 170 may include one or more memories 180, which may include a volatile or non-volatile memory (e.g., a flash memory, a random access memory (RAM), and/or a read-only memory (ROM)). The memory(ies) 180 may store instructions for execution by the processing device(s) 172, such as to carry out examples described in the present disclosure. The memory(ies) 180 may include other software instructions, such as for implementing an operating system and other applications/functions.

There may be a bus 182 providing communication among components of the processing system 170, including the processing device(s) 172, I/O interface(s) 174, network interface(s) 176, storage unit(s) 178 and/or memory(ies) 180. The bus 182 may be any suitable bus architecture including, for example, a memory bus, a peripheral bus or a video bus.

Although the present disclosure describes methods and processes with steps in a certain order, one or more steps of the methods and processes may be omitted or altered as appropriate. One or more steps may take place in an order other than that in which they are described, as appropriate.

As used herein, statements that a second item (e.g., a signal, value, scalar, vector, matrix, calculation, or bit sequence) is “based on” a first item can mean that characteristics of the second item are affected or determined at least in part by characteristics of the first item. The first item can be considered an input to an operation or calculation, or a series of operations or calculations that produces the second item as an output that is not independent from the first item.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The features and aspects presented in this disclosure may be embodied in many different forms and should not be construed as limited to the embodiments set forth herein. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. Where possible, any terms expressed in the singular form herein are meant to also include the plural form and vice versa, unless explicitly stated otherwise. In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The contents of all published documents identified in this disclosure are incorporated herein by reference.

1. A computer implemented method for detecting a target object within an environment:
obtaining a two-dimensional input image of a scene within the environment;
generating, using a machine learning based feature generation model, a feature map of respective feature vectors for the input image;
comparing the feature vectors included in the feature map with reference feature vectors generated by the feature generation model based on reference points within a reference image, wherein the reference image includes an reference object instance that corresponds to the target object;
based on the comparing, identifying points of interest in the input image that correspond to the reference points; and
determining a presence of the target object in the environment based on the comparing.

2. The method of claim 1 wherein the two-dimensional input image is obtained using a camera and includes two dimensional (2D) color data or grayscale data arranged in an array of pixels, each pixel corresponding to respective physical location within the scene, and the feature generation model generates the feature map in the absence of depth data for the pixels of the input image.

3. The method of claim 1 comprising training the feature generation model, the training comprising:
obtaining a set of training images that includes a plurality of corresponding image sets, each corresponding image set including multiple non-identical images wherein a plurality of same physical points are represented at different respective pixel locations across the multiple non-identical images;
generating an image label set for the set of training images, the image label set identifying, by respective pixel locations, groups of the same physical points across the multiple images included in each corresponding image set; and
using the set of training images and the image label set to train the feature generation model to generate pixel feature vectors with an objective of generating identical feature vectors for pixel locations that correspond to the same physical points.

4. The method of claim 3 wherein training the feature generation model comprises generating depth information for each of the corresponding image sets using a machine learning based depth generating model, wherein the generated depth information is used together with the set of training images and the image label set to train the feature generation model.

5. The method of claim 4 comprising:
obtaining, in addition to the two-dimensional input image, one or more further two-dimensional input images of the scene, the two-dimensional input image and the one or more further two-dimensional input images each corresponding to a different respective camera view of the scene;
generating, using the machine learning based feature generation model, a respective feature map of respective feature vectors for each of the one or more further two-dimensional input images; and
further comparing the further feature vectors included in the further feature maps with the reference feature vectors;
wherein identifying the points of interest in the input image is also based on the further comparing.

6. The method of claim 5 comprising obtaining the reference feature vectors, including:
obtaining the reference image and one or more further reference images, the one or more further reference images also each including a respective reference object instance that corresponds to the target object, the reference image and the one or more further reference images each corresponding to a different respective camera view;
identifying, for each of the reference points, a corresponding set of points across the reference image and the one or more further reference images that each map to a same physical location of the target object;
for each of the reference points, using the feature generation model to generate respective corresponding point feature vectors for each of the points included in the set of points corresponding to the reference point; and
for each reference point, generating a respective one of the reference feature vectors based on the respective corresponding point feature vectors generated for each of the points included in the set of points corresponding to the reference point.

7. The method of claim 6 comprising identifying the reference points, including:
receiving, through a user interface, user inputs selecting locations on the two-dimensional input image as the reference points, as part of a configuration phase.

8. The method of claim 6 wherein one or more cameras that are capable of capturing two-dimensional images but not enabled to capture an image depth dimension are used to obtain each of the two-dimensional input image, the one or more further two-dimensional input images, the reference image and the one or more further reference images.

9. The method of claim 3 wherein comprising retraining the feature generation model based on an updated set of training images that include one or more images previously obtained as two-dimensional input images of the scene.

10. The method of claim 3 comprising, prior to training the feature generation model:
presenting, using a user interface, selectable training mode options including a 3D scene learning mode and a 2D scene learning mode; and
receiving a user input selecting one of the training mode options,
wherein: (i) when the user input selects the 3D scene learning mode, the training includes generating depth information for each of the corresponding image sets using a machine learning based depth generating model and the generated depth information is used together with the set of training images and the image label set to train the feature generation model, and (ii) when the user input selects the 2D scene learning mode, the training is performed without depth information.

11. The method of claim 1 wherein obtaining the set of training images comprises, for each of the corresponding image sets:
obtaining at least a first image and a second image using different camera views.

12. The method of claim 1 wherein obtaining the set of training images comprises, for each of the corresponding image sets:
obtaining a first image that includes the object instance;
applying a translation function to the first image to obtain at least a second image.

13. The method of claim 1 comprising performing a physical action in respect of the target object based on the comparing.

14. A processing system comprising one or more processing devices and one or more memories coupled to the one or more processing devices, the processing system being configured for detecting a target object within an environment by:
obtaining a two-dimensional input image of a scene within the environment;
generating, using a machine learning based feature generation model, a feature map of respective feature vectors for the input image;
comparing the feature vectors included in the feature map with reference feature vectors generated by the feature generation model based on reference points within a reference image, wherein the reference image includes an reference object instance that corresponds to the target object;
based on the comparing, identifying points of interest in the input image that correspond to the reference points; and
determining a presence of the target object in the environment based on the comparing.

15. The processing system of claim 14 wherein the two-dimensional input image is obtained using a camera and includes two dimensional (2D) color data or grayscale data arranged in an array of pixels, each pixel corresponding to respective physical location within the scene, and the feature generation model generates the feature map in the absence of depth data for the pixels of the input image.

16. The processing system of claim 14 wherein the processing system is configured to train the feature generation model, the training comprising:
obtaining a set of training images that includes a plurality of corresponding image sets, each corresponding image set including multiple non-identical images wherein a plurality of same physical points are represented at different respective pixel locations across the multiple non-identical images;
generating an image label set for the set of training images, the image label set identifying, by respective pixel locations, groups of the same physical points across the multiple images included in each corresponding image set; and
using the set of training images and the image label set to train the feature generation model to generate pixel feature vectors with an objective of generating identical feature vectors for pixel locations that correspond to the same physical points.

17. The processing system of claim 16 wherein training the feature generation model comprises generating depth information for each of the corresponding image sets using a machine learning based depth generating model, wherein the generated depth information is used together with the set of training images and the image label set to train the feature generation model.

18. The processing system of claim 17 wherein the processing system is configured to:
obtain, in addition to the two-dimensional input image, one or more further two-dimensional input images of the scene, the two-dimensional input image and the one or more further two-dimensional input images each corresponding to a different respective camera view of the scene;
generate, using the machine learning based feature generation model, a respective feature map of respective feature vectors for each of the one or more further two-dimensional input images; and
further compare the further feature vectors included in the further feature maps with the reference feature vectors;
wherein identifying the points of interest in the input image is also based on the further comparison.

19. The processing system of claim 14 wherein the processing system is configured to cause a physical action to be performed in respect of the target object based on the comparing.

20. A computer readable medium storing a set of non-transitory executable software instructions that, when executed by one or more processing devices, configure the one or more processing devices to perform a method of detecting an target object within an environment, comprising:
obtaining a two-dimensional input image of a scene within the environment;
generating, using a machine learning based feature generation model, a feature map of respective feature vectors for the input image;
comparing the feature vectors included in the feature map with reference feature vectors generated by the feature generation model based on reference points within a reference image, wherein the reference image includes an reference object instance that corresponds to the target object;
based on the comparing, identifying points of interest in the input image that correspond to the reference points; and
determining a presence of the target object in the environment based on the comparing.
